(19) United States
(12) Patent Application Publication
(10) Pub. No.: US 2009/0031390 A1
(43) Pub. Date: Jan. 29, 2009

(54) METHOD AND APPARATUS FOR SYNCHRONIZED TRANSMISSION AND RECEPTION OF AUDIOVISUAL DATA AND INDEX DATA IN INTERNET PROTOCOL TELEVISION APPLICATIONS FOR IMPLEMENTING REMOTE NETWORK RECORD WITH INSTANT PERSONAL VIDEO RECORDER SUPPORT

(75) Inventors: Yasantha Nirmal Rajakarunanayake, San Ramon, CA (US); Jose Antonio Rubio, San Diego, CA (US); Sanjeev Sood, San Diego, CA (US)

Correspondence Address: BRAKE HUGHES BELLERMANN LLP;c/o Intellevate, P.O. Box 52050, Minneapolis, MN, 55402, US

(73) Assignee: Broadcom Corporation, Irvine, CA (US)

(21) Appl. No.: 11/828,770

(22) Filed: Jul. 26, 2007

(51) Int. Cl. H04N 7/16

(52) U.S. Cl. 725/142

(57) ABSTRACT

A method includes receiving an audio, video, or audiovisual broadcast at a first settop box, where the audio, video, or audiovisual broadcast includes digital media data encoding a program. Index data is generated based on the received digital media data encoding the program, and data packets are transmitted from the first settop box through a network to a network storage server. The transmitted data packets include data encoding the program and the index data. The transmitted index data is stored in an index file in a memory device of the storage server, and the transmitted data encoding the program is stored in a digital media data file in the memory device of on the storage server. The index data in the index file are configured to provide locations of data in the stored digital media data file marking entry points for playing back the digital media data file.

This description relates to streaming of digital media over a network from one network device to another, in particular, to a system and method for the synchronized transmission and reception of audiovisual data and index data in Internet Protocol (IP) television applications for implementing remote network recordings with instant personal video recorder support.

### BACKGROUND

As Internet based broadband systems have become widely deployed, the display of high-quality streaming media (e.g., television signals) delivered through Internet protocol (“IP”) based networks has been contemplated. Many vendors seek both to display media as well as to stream digital media in various customer premises, including digitally connected homes. However, because of the high bandwidth and processing power required to deliver and display digital video, it is quite challenging to provide high quality IP-based television (“IPTV”) functionality using traditional settop box (“STB”) capabilities.

Moreover, homes can be equipped with multiple STBs to provide for the rendering of television programs at multiple locations within the home (e.g., living room, kitchen, various bedrooms), which can complicate the storage and rendering of digital data across a network connecting devices at the different locations. A particular problem is the difficulty in handling so called “trick modes” of playing back digital data over a network (e.g., fast forwarding, playing in reverse, and skipping forward or backward). Execution of such trick modes generally requires index data to organize and track audio and video data and its location on a storage device, however, automatic generation of such index data is computationally-intensive and therefore expensive. At the same time, it can be difficult to pre-generate index data to save computational power because the audiovisual data to be rendered is often encrypted when distributed over the network.

### SUMMARY

In a first general aspect, a method includes receiving an audio, video, or audiovisual broadcast at a first settop box, where the audio, video, or audiovisual broadcast includes digital media data encoding a program. Index data is generated based on the received digital media data encoding the program, and data packets are transmitted from the first settop box through a network to a network storage server. The transmitted data packets include data encoding the program and the index data. The transmitted index data is stored in an index file in a memory device of the storage server, and the transmitted data encoding the program is stored in a digital media data file in the memory device of on the storage server. The index data in the index file are configured to provide locations of data in the stored digital media data file marking entry points for playing back the digital media data file.

Implementations can include one or more of the following features. For example, the received digital media data encoding the program can be decrypted, and data encoding the program can be encrypted prior to transmitting the data packets that include the encrypted data from the first settop box to the storage server. At least some of the transmitted data packets can include both data encoding the program and index data. The transmitted data packets that comprise both data encoding the program and index data can be parsed at the storage server to separate the data encoding the program and the index data.

The program can be streamed from the storage server to a settop box for playback with the settop box, and at least one entry point in the program can be located based on index data stored in the index file in response to a trick mode request from the settop box. The settop box to which the program is streamed can be a second settop box that is different from the first settop box. The streaming and the locating in response to a trick mode request can occur while the data packets are transmitted from the first settop box through the network to the network storage sever.

The index data can be loaded into a first buffer on the first settop box, and the data encoding the program can be loaded into a second buffer on the first settop box, and transmitting the data packets from the first settop box through the network to a network storage server can include reading index data and data encoding the program from the buffers and generating the data packets based on the read-out data.

The index file can include SCIT data. The network can include a wireless network. Transmitting the data packets from the first settop box through a network to the network storage server can include transmitting the data packets according to a TCP/IP network protocol. The first settop box and the network device can be located within the same building.

In another general aspect, a system for allowing trick mode playback of a digital media program over a network includes a first settop box, and the settop box includes a tuner, and index data generation engine, a first buffer, a second buffer, and a network interface device. The tuner is adapted to receive an audio, video, or audiovisual broadcast, where the audio, video, or audiovisual broadcast includes digital media data encoding a program, and is further adapted to demultiplex the program from the broadcast. The index data generation engine is adapted to generate index data based on the digital media data encoding the program. The first buffer is adapted to store the index data, and the second buffer is adapted to store data encoding the program. The network interface device is adapted to transmit data packets through a network to a network storage server, where the data packets include data encoding the program and the index data that have been read out of the second and first buffers, respectively. The index data can be used to provide locations of data in the digital media data file stored on the storage server marking entry points for playing back the digital media data file from the storage server.

Implementations can include one or more of the following features. For example, the network can include a wireless network. The first settop box can be a diskless settop box. The first settop box can include a RAVE that includes the index generation engine.

The system can also include a storage server connected to the first settop box through the network, where the storage server includes a memory device adapted to store the index data received from the first settop box in an index file and adapted to store data encoding the program in a digital media data file. The first settop box can be located within the same building as the network device. The storage server can also include a playback engine adapted to stream the program from the storage server to a settop box for playback with the settop box, and to locate at least one entry point in the program based on index data stored in the index file in response to a trick mode request from the settop box. The settop box to which the program is streamed can be a second settop box that is different from the first settop box or can be the first settop box. The playback engine can be adapted to stream the program and locate the entry point in response to a trick mode request while the data packets are transmitted from the first settop box through the network to the network storage server.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a local area network for recording and playing back television programs on a variety of devices connected to the network.

FIG. 2 is a flow chart of a method in which a session is established for recording a television program from a settop box to the permanent storage device of the network storage server over a network.

FIG. 3 is a schematic diagram of a record audio video engine (RAVE).

FIG. 4 is a schematic diagram of a system including a settop box adapted for relaying digital television programs and index over a network to a storage server for storage on the storage server.

FIG. 5A is a block diagram of packet for transporting the data as shown in FIG. 4.

FIG. 5B is a block diagram of packet for transporting the data as shown in FIG. 4.

FIG. 6 is a flow chart of an exemplary method than can be implemented using the devices and techniques described with reference to FIGS. 1-5B.

### DETAILED DESCRIPTION

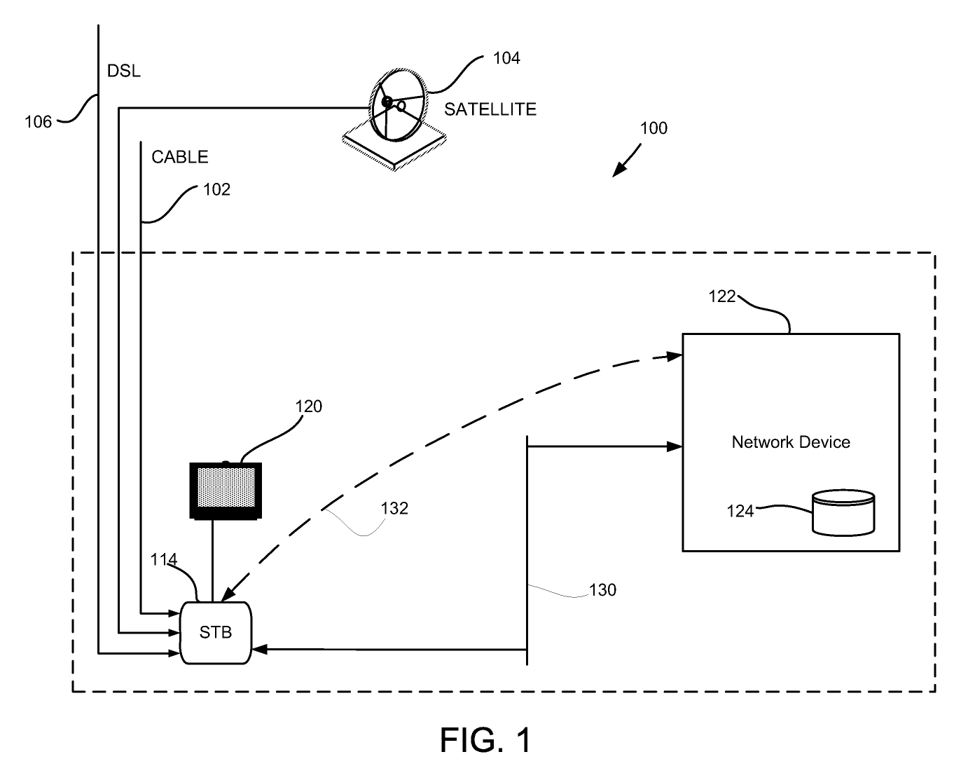

FIG. 1 is a block diagram of a local area network (LAN) 100 for recording and playing back television programs on a variety of devices connected to the network. Digital audiovideo broadcasts carrying digital media data can be received from one or more broadcasters that broadcast signals that encode audiovideo programs. For example, a broadcaster may broadcast signals that encode audio programming (e.g., music, news, talkshows, etc) for playback by a listener or a broadcaster may broadcast signals that encode one or more television programs for playback to a viewer. Although the broadcast, reception, and playback of all types of digital audio, video, and audiovideo programming via digital media data is contemplated, here we focus on the audiovideo television programming, merely for clarity.

In one example, an affiliate of a television network (e.g., ABC, NBC, CBS, FOX) can broadcast a television program on a very high frequency (VHF) channel or on an ultra high frequency (UHF) channel, and the broadcast can be received by the LAN 100 for playback. A television broadcaster also can broadcast multiple signals for encoding multiple televisions programs. For example, a cable television provider can broadcast multiple television programs over a cable 102 that is routed to the LAN 100, so that one or more programs can be selected from the broadcast for viewing or recording on a device connected to the LAN. Other broadcast mechanisms are also possible. For example, multiple television programs can be broadcast over a satellite connection 104 to the LAN 100. In another example, multiple television programs can be broadcast over a high-speed Internet connection (e.g., a digital subscriber line (DSL) connection 106 to the LAN 100. Thus, the television program can be received from a variety of signal sources, including, for example, a satellite dish, a coaxial, cable, a telephone line (including DSL connections), a broadband over power line connection, an IP Network, or a VHF or UHF antenna.

When a television broadcast is received at the LAN 100, a television program carried by the broadcast signal can be routed to a STB 114 that is connected to a television display device 120. Generally, the STB 114 routes television programs and digital signals that encode the television program. If the television broadcast is an analog broadcast (e.g., a VHF or UHF broadcast), an analog to digital converter in the STB can convert the incoming analog signal into an outgoing digital signal. The digital signals can be encoded and compressed before transmission and storage. The television display device 120 can be any display device for rendering a television program to a viewer, for example, a traditional cathode ray tube (CRT) based television set or a flat panel plasma or liquid crystal display (LCD) based device. The display device normally associated with a personal computer (e.g., a computer monitor) can also be used as a television display device. The STB 114 can include electronic tuner circuitry adapted for demultiplexing a television program from the television broadcast received by the LAN 100, so that the program can be rendered on the display device associated with the STB. The STB can be a built-in component of the display device (e.g., in the case of a “cable ready” television set, or DTV), or the STB can be an external device that is connected to the display device by one or more wires. For example, special external digital STB's can receive a digital television broadcast and decode the broadcast for a television set that does not have a built-in digital tuner. In the case of direct broadcast satellite (mini-dish) systems, such as those offered by SES Astra, Dish Network, and DirecTV, the STB can be an integrated receiver/decoder.

Within the LAN 100, the STB 114 can be connected though a digital network to a network device 122 the records or plays back a television program. Thus, the STB 114 can stream the television program through the network to the network device, where the program will be processed (e.g., played back or recorded). For example, in one implementation, the network device 122 can be another settop box connected to a display device that receives the television program and plays back the program on a display device. In another implementation, the network device can be a network storage server that includes a permanent storage medium (e.g., hard disk storage or an optical disk storage) 124 for storing television programs received at the LAN 100 from the cable connection 102, the satellite connection 104, or the Internet connection 106, so that the stored programs can be played back on a display device 120 sometime after the programs were received. The STB 114 can be connected to the network storage server 102 via a wired network connection 130 or a wireless network connection 132. The wired network connection 130 can be an Ethernet network through which the STB 114 can communicate with the network storage server 122, and the wireless network connection 132 can be an 802.11 wireless network through which a STB 114 can communicate with the network storage server 122. The LAN 100 can exist, for example, within the home of a subscriber of various television programs. Thus, in some implementations, the subscriber may have multiple display devices 120 positioned in different locations within the home, and the display devices can be connected to different STBs 114. In one implementation, the STB 114 in the subscriber's home can be connected to a single network storage server 122 that can be used to store television program for later playback. In such an implementation, each STB 114 connected to the storage server need not include a permanent storage device for storing television programs. Rather, this “edge device” can be equipped with circuitry for decoding television program signals for playback on the display device 120, where the television program is received either from outside the LAN 100 (e.g., from the cable connection 102, the satellite connection 104, or the Internet connection 106) or from the network storage server connected to the LAN, but can be built more economically than a STB that must include a local permanent storage device for storing programs for timeshifted playback.

When a television broadcast is received at the LAN 100, a television program in the broadcast can be played back on the display device 120 while simultaneously storing the television program on a permanent storage device 124 connected to the network. A television broadcast can be received from the cable network 102, the satellite network 104, or the broadband network 106, and a television program within the broadcast can be stored on the storage device 124 while simultaneously rendering a program within the broadcast on a playback device 120 connected to the network. The display device 120 and the STB 114 locally connected to the display device can be diskless, such that recording of the television program must be stored on a networked storage device 124, such as the storage device on the network storage server 122. Then, a timeshifted version of the television program can be received at a STB 114 from the network storage server 122 for playback on the display device and played back on the display device 120.

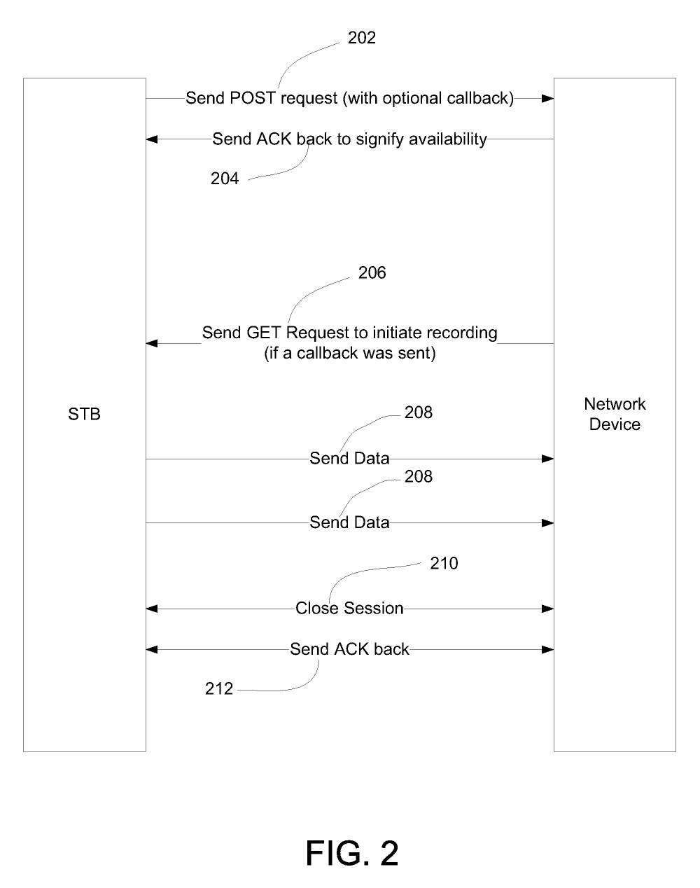

FIG. 2 is a flow chart of an exemplary method in which a network session can be established the STB 114 and the network device 122, such that a television program can be streamed according to a network protocol from the STB 114 to the network device 122 for recording at the network device. For example, a user of the STB 114 (e.g., subscriber of the television broadcast received over the connection 102, 104, or 106) can program the STB 114 to record a user-specified television program from the television broadcast to a network-connected storage server 124. In one implementation, the STB 114 that initiates the recording can send a message with a callback uniform resource locator (URL) or uniform resource identifier (URI) to the network storage server 122, so that the storage server 122 can pull the television program from the STB for recording.

The control of the recording can be performed by a passive control flow socket via an HTTP connection using a TCP/IP protocol between the STB 114 and the network storage server 122 with a simple initial message from the STB 114 and a response from the storage server 122. The record session can be closed by closing the TCP/IP connection between the STB 114 and the storage server 122. Either the STB 114 or the network storage server 122 can close the session, and the closure of the session can include closure of the passive flow control socket by a close socket connection message to the network storage server 122 by the STB 114.

As shown in FIG. 2, the record process on the network storage server 122 can be started with a trigger from the STB 114, and this can be implemented with a HTTP server process attached to a local TCP Port-number. Thus, a recording session can be initiated by the STB 114 issuing a POST command to the network storage server 122 (step 202), and an acknowledgment response from the network storage server (step 204). When the POST command is issued in step 202 a callback request can optionally be sent from the STB to the server. If a callback request is sent, then the server sends an HTTP GET request to the STB to initiate the recording (step 206).

The STB 114 uses information about the IP-address/name of the network storage server 122, the server TCP port number, the availability of this network record service, and how to access it to stream data to the storage device 122. With each recording session the following information can be specified to the storage server 122: the video filename of the television program being recorded; the video type, which can be defaulted to Moving Picture Experts Group (MPEG) type, but which can also be another video type, such as, packetized elementary stream (PES) or Advanced Video Coding (AVC); the program clock reference (PCR); program ID (PID), or Video PID. Other information can also be provided, such as, for example, an audio PID, and audio type, the duration of the program, etc. If more than one television program is being recorded from the television broadcast, then multiple PID's can be specified to the network storage server 122. Additionally, a callback uniform resource identifier (URI) can be provided with the POST request to the network storage server 122, so that the server can pull record data from the STB 114, over an IP protocol.

Messaging between the STB 114, and the storage server 122 can be performed using HTTP header options, which specify recording parameters and provide a simple way to parse and understand parameters passed by STB 114 to the server 122. An example HTTP header for a record request, with a hypothetical schema identified by the tag “Network-AV-Record.schemas.broadcom.com,” is shown below in Table 1.

TABLE 1
HTTP Header for Record Request:
POST /record-url HTTP/1.1
Content-Type: text/html
Network-AV-Record.schemas.broadcom.com:
File-Name: Jurassic-Park.mpg
Network-AV-Record.schemas.broadcom.com: Event-Start: Sat, 01
Jan 2006 00:05:30 GMT
Network-AV-Record.schemas.broadcom.com: Event-Duration =
1:30:00.000
Network-AV-Record.schemas.broadcom.com: Connection = keep-
alive
Network-AV-Record.schemas.broadcom.com: Event-URL =
http://192.168.1.101:5000/record0
Network-AV-Record.schemas.broadcom.com: Event-Type = Live-
Event
Network-AV-Record.schemas.broadcom.com: Video-Type: Mpeg2-TS
Network-AV-Record.schemas.broadcom.com: Audio-Type: 0x81
Network-AV-Record.schemas.broadcom.com: Audio-PID: 0x34
Network-AV-Record.schemas.broadcom.com: Video-PID: 0x31
Network-AV-Record.schemas.broadcom.com: PCR-PID: 0x31
Network-AV-Record.schemas.broadcom.com: Encryption-Type:
3DES
Network-AV-Record.schemas.broadcom.com: Client-ID: xxxx-
xxxx-xxxx-xxxx-xxxx-xxxx
Network-AV-Record.schemas.broadcom.com: Version: 1.0.1

The first line in the HTTP header identifies the record-URL, which can be advertised by the network storage server 122 to the STB, and also identifies the HTTP protocol version. Different record-URL's may be advertised by an individual network storage server 122, depending on various policy-based constraints on content streamed to the server. The “Content-Type” line indicates the media type of the data sent to from the STB to the network storage server 122.

The “File-Name” is the suggested filename of the file for storing the television program stored on the server 122. The “Event-Start” field instructs the network storage server 122 to start the recording by connecting to the STB 114 at the specified universal time, but if the recording is required immediately, this field may be omitted. The “Event-Duration” field instructs the server 122 to record up to and no more than the specified number of hours:minutes:seconds.milliseconds from the Event Start time, and provides a mechanism to limit duration on the recording on the storage device 124 of the storage server 122.

The “Event-URL” is the callback URL for the server 122 to connect to the STB 114 to receive the binary data related to the video recording requested. It is the STB's responsibility to start the content immediately after the response from the server is received. The URL usually specifies an HTTP protocol. However, other formats are possible, such as Real-time Transport Protocol (RTP) and User Datagram Protocol (UDP), so that other URL formats would be usable. The event URL is optional, and recording may immediately commence by clients sending the data directly to the server's record URL.

The “Event-Type” field can be used to identify if the recording is a live event, a real-time event, or a pre-recording that is available locally on a disk of the STB. This allows the network storage server 122 to prioritize the STB, so that minimal loss of packets will result for recordings that are most sensitive to packet loss. Also, this field can provide information about average bit-rate to be expected during the recording session.

The “Video-Type” field specifies the type of digital video transmitted from the STB 114 to the network server. The video type could be MPEG, PES, AVC, etc. This field allows the network storage server 122 to create a file about the particular video type in the binary record stream. When a STB 114 wants to playback the recorded television program this field allows the server 122 to hint the STB 114 to use the specific video type. Similarly, the “Audio-Type” field specifies the audio type and allows the server 122 to create a file about the particular audio content in the binary record stream and to hint a STB 114 that wants to playback this content to use the specific audio type.

The “Audio-PID” field identifies the audio program associated with the television program that is to be recorded. One or more audio programs may be present in the recording, and a secondary audio PID, or various languages, etc. can be specified with this field. The Audio-PID field allows the network server 122 to hint a STB 114 that wants to playback this content to use the audio program associated with the specific audio PID. Similarly, the “Video-PID” field identifies the video program and is used by the network server 122 to create a file about the particular video content in the binary record stream, which allows the server 122 to hint a STB that wants to playback this content to use the video content specified by the specific video PID.

The “PCR-PID” field is used for an mpeg transport stream and specifies the program clock reference. It can be used for software indexing of transport streams at the network server 122. An “Encryption-Type” value can be send from the STB 114 to the network storage server 122, and designation codes such as “encrypt at client,” “encrypt at server,” “decrypt at client,” “decrypt at server,” and encryption algorithms such as 3DES, AES, etc. can be designated with this field.

The “Client-ID” field can be used for the network storage server 122 to keep track of clients. Optionally, a unique client ID could be negotiated by the STB with the server, or an industry standard Universally Unique Identifier (UUID) or Globally Unique Identifier (GUID) could be used. In one implementation, a server-assigned cookie identifying the STB or a user ID could be assigned to keep track of a client. If the STB device 114 is simultaneously recording more than one program to the network storage server 122, a session ID and separate callbacks (i.e., event-URL's for the server 112 to identify independent record streams from different STB 114) can be provided to identify the different television programs being recorded. The “Version” field can be attached to the header fields to identify the schema version that is supported, which allows network storage servers 112 to operate with backward compatibility to older STB 114.

The HTTP protocol described above allows control of the recording by a third party. For example, a user may use a browser to create a simple HTML form with the above described fields, and the form can be forwarded to a STB 114 and the network storage server 122 to initiate a recording transaction from the STB to the server 122. The protocol described here is therefore capable of a three-party model, with the server, the STB, and a control station being independent of each other, which allows flexibility in administering the recording transactions. Alternatively, more elaborate extensible markup language (XML)-based schemas can be developed to address the needs of network recordings. By using the HTTP protocol and associated parameters to describe the recording any guesswork that must be done at record time or playback time, in auto-detecting content types, which is often a costly CPU and costly resource operation, can be minimized or eliminated.

When a recording of a television program needs to be started, it can be initiated by a timer event or a remote control event, or other user event on STB-side of the network. Then, a TCP socket can be created, and an appropriate HTTP POST message can be sent from the STB to the server 122, with the required parameters (e.g., the filename, PCR-PID, and callback URL) any of the optional parameters described above. When recording a live television program, the recording must start shortly after a positive acknowledgement (step 204 in FIG. 2) is received from the server 122 to STB 114. Then, the television program to be recorded is sent from the STB 114 to the server 122 (step 208). The recording session is terminated when either the STB 114 or the server 122 closes the control socket (step 210) and an acknowledgment is sent back from the server 122 or the STB 114, (step 212) or when the content duration expires on server-side of the network.

When a network session is established between the STB 114 and the network device 122, a television program can be streamed with high efficiency from the STB 114 to the network device using techniques described in more detail below. While streaming the television program, the STB 114 can simultaneously playback the television program to an attached display device 120. Trick modes also can be used when playing back the television program from the network storage device 122 to the attached display device 120 connected to the STB 114. This feature provides digital video recorder (DVR) like capabilities to low-powered end-stations using network attached storage. Because the live program (received via Cable, Satellite, Off-air Broadcast, Analog or even Internet Video received via DSL/Cable Modem) cannot be buffered to a hard disk if the STB 114 does not include local disk capability, the same buffers that are used in decoding/de-multiplexing the television program from the television broadcast received at the STB 114 can be used while rendering the television program on the attached display device 120 and can provide a just in time streaming (JITS) mechanism for streaming the program to the network device 122 that is both error free and efficient with respect to CPU usage.

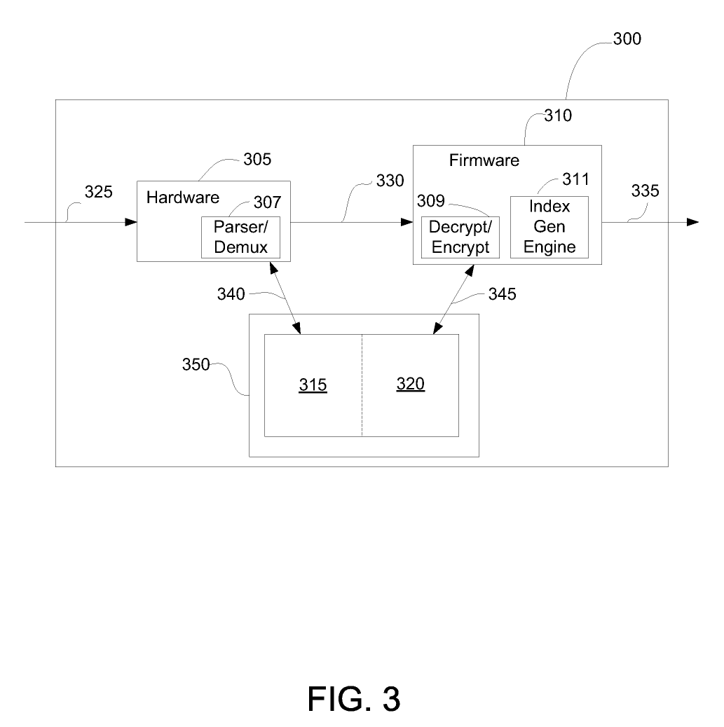

FIG. 3 is a schematic diagram of a record audio video engine (RAVE) 300, which is described in further detail in U.S. patent application Ser. No. 11/348,563, filed on Feb. 7, 2006, in U.S. patent application Ser. No. 11/345,468, filed on Mar. 21, 2006, and in U.S. patent application Ser. No. 11/273,102, filed on Nov. 11, 2005, all of which are incorporated herein by reference. The RAVE 300 can be used by the STB 114 to handle incoming television broadcasts, demultiplex a television program from the broadcast, decrypt an encrypted program, generate an index file of the audiovideo data for the program, and temporarily buffer packets of the program. In some implementations, the RAVE 300 may perform a wide variety of tasks and may operate with the different input formats. For example, the RAVE 300 may provide ancillary information about the incoming data to assist a downstream device in the storing, decoding, or playback of the data; the RAVE 300 may provide timestamp management support; the RAVE 300 may provide methods for synchronizing commands from software with the data stream; the RAVE 300 may provide flexibility to support new, as-yet unanticipated formats, and the ability to do all of the aforementioned functions at high speeds such as, for example, 100+ Mbits/sec. In this regard, a fast yet programmable solution may be desirable.

The RAVE 300 may include a hardware assist block 305, a firmware block 310, and a memory block 350 and can receive input data 325 (e.g., a television broadcast received from connection 102, 104, or 106). The input data 325 can include packets of video, audio, and record data in any number of formats. After receiving the input data 325, the hardware assist block 305 can perform some processes and pass processed data to a firmware block 310, either directly via data path 330 or indirectly via the buffer block 350. The processed data may be passed from the hardware assist block 305 via data path 340 to the memory block 350, which may then be accessed by the firmware block 310 via data path 345.

The hardware assist 305 block can include, for example, a parser/demultiplexer 307 that acts to demultiplex data streams corresponding to individual television programs that are part of the television broadcast received from a connection 102, 104, or 106 and that may perform parsing of formatted incoming packets (e.g., MPEG packets). The hardware assist block generally performs functions that are relatively unlikely to change such as, for example, MPEG parsing, and demltiplexing, and the firmware block 310 may make most or all of the final decisions of the RAVE 300. Functions that may change as a result of, for example, a new data format may be processed mainly by the firmware 310 with some processing that may be done by the hardware assist 305. The firmware block 310 may include a decryption/encryption engine 309 that may be used to decrypt an incoming data stream 325 if the incoming data stream is encrypted and that may be used to encrypt an outgoing data stream 335 if the particular application calls for the outgoing data stream to be encrypted.

When a data stream of sequentially received packets, which includes, for example, packets A, B, and C, is received by the RAVE 300, a current packet, packet A, may come into the RAVE 300 via input 325. The hardware assist 305 may perform a portion of the functions associated with the processing of packet A, and may retrieve information associated with packet A as well. The hardware assist 305 then writes retrieved information (e.g., the data payload of a received packet) to a location in the memory block 350 such as, for example, a first buffer 315.

After the hardware assist 305 performs the portion of the functions associated with the first packet A, the firmware 310 may access and begin processing the data associated with the first packet A from the buffer 315 and may output the processed data. Meanwhile, while the firmware 310 is processing the previously received first packet A, the hardware assist block 305 may process the next packet (i.e., packet B) and write the associated retrieved data in another location in the memory block 350 such as, for example, a buffer 320. The firmware 310 may then begin processing the packet B from the buffer 320, and the hardware assist 305 may process the next packet (i.e., packet C). The hardware assist 305 can write the associated information into the buffer 315, overwriting the data associated with the packet A previously processed by the firmware 310, if permission is granted to overwrite the previous data.

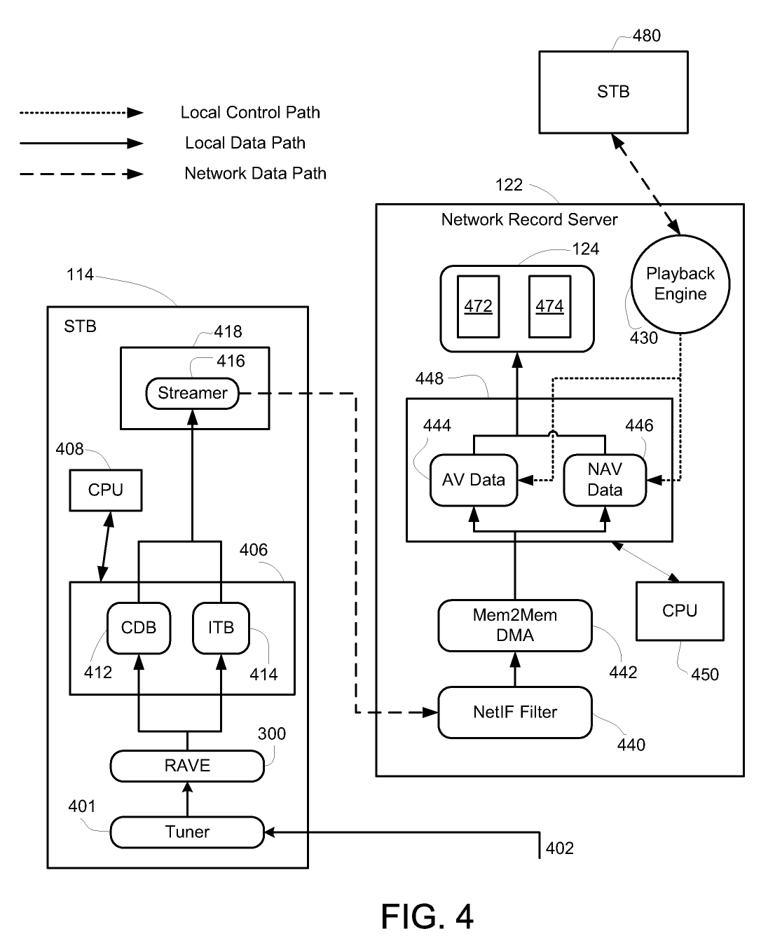

FIG. 4 is a schematic diagram of a system 400, which includes a STB 114, for the reception and playback of digital media data and for the relaying of digital media data to a network attached server 122 from which the digital media data can also be played back over a network to one or more STB 114. Certain exemplary structures are shown in FIG. 4 as being part of one particular implementation of the STB 114. For example, the STB 114 can include a RAVE 300 and a central processing unit (CPU) 408 that is operatively coupled to a main memory device 406. The RAVE is also operatively coupled to the main memory 406.

As shown in FIG. 4, a television broadcast can be received over a connection 402, and a program can be selected from the broadcast with a tuner 401. In FIG. 4, command and control path flow is represented by dashed lines; while the data path is shown as solid lines. In one implementation, the television program can be encoded in the Motion Pictures Expert Group (MPEG) format and can be transferred to the STB 114 using the TCP/IP protocol. A decryption engine 309 within the RAVE 300 can decrypt encrypted transport stream packets received over the connection 402, and a parser/demultiplexer 307, which can be part of the hardware assist block 305 of the RAVE 300, can demultiplex the desired program from the broadcast and can parse the packets of the desired television program from the incoming data stream. The RAVE 300 can process the incoming data stream that includes the television program that the user desires to record over the network to the network storage server 122. During this processing the RAVE 300 can output the digital media data (e.g., in an elementary stream (ES) format or in a packetized elementary (PES) format) into a compressed table buffer (CDB) 412. The RAVE 300 also can generate and output index data into an index table (ITB) 414 for use in synchronizing the playback of the television program from the digital media data. The index data can include programmable clock reference (PCR) data or start code table data that are used to synchronize and index the digital media data. Digital media data in the CDB 412 can be multiplexed together with the index data in the ITB 414 by a streaming engine 416 within a network interface device 418 and sent out over the network 130 to the network storage server 122, where it can be stored for later playback. Prior to sending the data out over the network the encryption engine 309 can encrypt the data so that it is protected while traveling over the network. Thus, in some implementations, clear data may exist only within the RAVE, after an incoming encrypted data stream is decrypted by the decryption engine 309 and prior to encrypting the processed data and sending the encrypted data out over the network.

Because of the presence of clear data within the RAVE 300, the RAVE 300 represents an opportune location for generating index data and for off-loading the task of generating index data from both the CPU 408 of the STB 112 and from the network storage server 122, whose processing resources may be consumed by other tasks, such as, for example storing data streams to a hard drive 124 or serving one or more television programs over the network 130 to a number of different STB's 114 that may be connected to the network storage server 122. The index data generated by the RAVE (for example, by an index generation engine 311 within the firmware 310 of the RAVE 300 can be sent out of the RAVE in approximately 24 byte chunks that correspond to approximately 1316 byte chunks payload data from the transport stream packets (e.g., corresponding to the payload of seven 188 byte MPEG packets that can be sent in a TCP/IP frame). The index data can be stored temporarily in the ITB buffer 414, while the corresponding payload data can be stored temporarily in the CDB buffer 412. Then, the streaming engine 416 can fetch payload data from the CDB buffer 412 and index data from the ITB buffer 414 and can packetize the digital media data and the index data together for sending over the network to the network storage server 122.

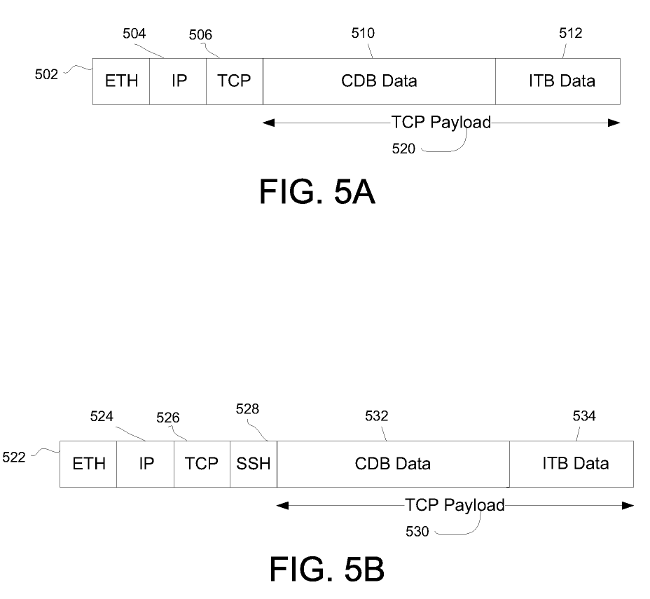

FIG. 5A and FIG. 5B show exemplary packet structures for sending the digital media data and the index data over the network 130 from the STB 114 to the storage server 122. The exemplary packet shown in FIG. 5A includes an Ethernet header 502, an IP header 504, a TCP header 506, and a TCP payload portion 508 that includes digital media data 510 from the CDB buffer 412 and index data 512 from the ITB buffer 414. The exemplary packet shown in FIG. 5B includes an Ethernet header 522, an IP header 524, a TCP header 526, a session-specific header 528 and a TCP payload portion 530 that includes digital media data 532 from the CDB buffer 412 and index data 534 from the ITB buffer 414. The session-specific header may be defined anew each time a new TCP/IP session of HTTP session is established between the STB 114 and the storage server 122 to transfer a television program from the STB to the server 122 and can contain information to inform the receiving device (e.g., the storage server 122) about the size of the CDB data field 532 and the size of the ITB data field 534, so that the receiving device can know where to expect to find the digital media data and the index data within the packet and then can appropriately parse received packets into digital media data and index data. When the header shown in FIG. 5A is used to transport multiplexed digital media data and index data, the digital media data field 510 and the index data field 512 can have fixed predetermined sizes, so that the receiving device can know where to expect to find the digital media data and the index data within the packet and then can appropriately parse received packets into digital media data and index data. The index data contained within the index field 512 or 534 can refer to the digital media data contained in the CDB data field 510 or 532 of the same packet that carries the index data, but the index data can also refer to digital media data carried in a different packet that is transmitted before or after the packet containing the index data. This is because the transmitted digital media data can include B-frames and P-frames that require the prior decoding of some other frames in order to be decoded.

Referring again to FIG. 4, the STB 114 can send a multiplexed stream of digital media data and index data over the network 130 to the network storage server 122. The network storage server 122 receives the multiplexed stream through a network interface filter 440, which passes the stream to a demultiplexer and memory-to-memory direct memory access (DMA) engine 442, which writes the digital media data from the multiplexed stream into an audiovisual data buffer 444 in a main memory 448 of the server 122 without requiring significant processing resources from the CPU 450 of the server 122. The DMA 442 also writes the index data from the multiplexed stream into a Navigation format (NAV) data buffer 446 in the main memory 448 without requiring significant resources from the CPU 450. The index data can be written into files using a number of different file formats, including the Navigation File format, developed by Broadcom Corporation in Irvine, Calif. From the buffers 444 and 446 in the main memory 450, the digital media data and the index data, respectively, can be written to the hard disk 124 of the storage server 122. For example, index data from the NAV data buffer 446 can be written into an index file (e.g., a start code index table (SCIT)) 474, and the digital media data from the audiovisual data buffer 444 can be written to a digital media file 472. If the digital media data were received in an encrypted form they can remain in an encrypted form when stored to the hard disk 124 in the digital media file 472, which can also be known as a transport stream file.

Then, when the storage server is called upon to stream out the digital media data of the television program over the network 130 for playback on a display device connected to a STB 114, the index data can be used by an playback engine 430 to perform trick modes (e.g., fast forwarding, rewinding, pausing, and seeking) when playing back the program. Because the network storage server 122 receives both the digital media data and the index data from the STB 114, when the server 122 is called upon to playback the digital media data to a display device connected to a STB 480, the playback can occur not only from the beginning of the file at normal speed, but the index data also can be used to enable playback using trick modes. For example, the index data can be used by a playback engine 430 to seek a playback starting point within the program that is not the beginning of the program.

Thus, to support trick modes during playback, the server 122 has a way to randomly access the recorded digital media file 472 stored in the storage device 124 to retrieve the correct transport stream data to provide the desired playback to the user. In one implementation, this may be achieved by marking certain entry points in the transport stream that would efficiently allow a complete picture to be decoded. Thus, collection of data points that include entry points for a digital media program can form the index file 474. For example, the location of I-frames in the transport stream could be marked and stored in the index file 474, so that digital media data encoding those I-frames can be quickly and efficiently located and played back by referring to the index file 474.

As described herein, by using the TCP/IP protocol for transporting multiplexed digital media data and index data from the STB 114 to the storage server 122, it can be ensured that packets are not dropped or lost during transmission. This is important, because if a packet were dropped, such that the correspondence between digital media data arriving in AV data buffer 444 and index data arriving in NAV buffer were upset, then the index data could point to the incorrect digital media data, in which case the rendering of the television would be corrupted. Also, generating the index data for the television program in the RAVE 300 of the STB 114, which is connected over the network to the storage server 122, a computationally-intense task is offloaded from the CPU 450 of the storage server 122 to a network device, thus freeing up resources of the storage server to serve television programs to multiple network-attached devices.

Thus, as shown in FIG. 4, a streamlined method is illustrated for offloading the CPU 408 of the STB 114 and the CPU 450 of the storage server 122 from packet handling whenever possible. Incoming data 402 is received by the tuners 401, and demodulated and assembled into a digital data stream and routed to a transport demux interface. The packets are optionally decrypted and accumulated in the RAVE buffers (belonging to the main host memory). Digital media data in the CDB data buffer 412 is optionally re-encrypted/scrambled by the RAVE for network transmission. The index data is also generated simultaneously by the RAVE but generally remains unencrypted. When sending the digital media data over the network 130, the index data is piggybacked onto the end of the TCP/IP packets that contain the digital media data. In one implementation, seven MPEG transport packets (188×7 bytes) are transported as the video data payload by a packet sent over the network 130 in an TCP/IP packet. In this timeframe, several index data TB entries may be generated by the RAVE hardware and firmware. The index data ITB entries have a fixed size, which in one implementation can be about 24 bytes per ITB. At the reception end on the storage server 122, a simple protocol/convention can be used to delineate CDB data from ITB data. For example, if the payload data packet length is larger than 188×7 bytes, then, according to the protocol, index data can be defined to exist in the payload of the packet, and the payload packet length minus 1316 bytes gives the size of the index data chunk. A more elaborate protocol could be used with separate header fields (e.g., the session-specific header field 528) for other applications.

Within the STB 114 an ultra direct memory access (UDMA) engine within the streaming engine 416 of the outgoing network interface device 418 assembles packets from discontiguous sections of memory (the UDMA uses multiple descriptors per packet), and this allows transmission of the data in the RAVE buffers directly, while the hardware is still recording the next section of the data. The UDMA of the streaming engine 416 can do this multiple scatter gather operation. Optionally, for a network interface device 418 that does not support a DMA scatter gather (e.g., universal serial bus (USB) network interface devices and wireless adapters) two processes can be used to copy the packet payload from one section of memory to another. A memory-to-memory DMA stage can be used to transfer data to a buffer/format suitable for transmission.

A pipeline process of operating the memory-to-memory DMA as soon as data is available in the RAVE buffers 412 and 414 can offload the main CPU 408 from the essential task of copying data. In the absence of a UDMA capability on the network interface device 418 (e.g., when sending data out of USB interfaces), a separate memory-to-memory DMA engine can be used. In this case both RAVE 300 and ITB index data along with the header gets DMA'ed to the network transmit buffer using the memory-to-memory DMA. This method can be applied for wireless or Peripheral Component Interconnect (PCI) based network interface devices.

Thus, disclosed here in are systems and methods that allow multiple end stations (e.g., client STB's) to receive programming from various physical mediums (e.g. Satellite, Cable, DSL etc.) and to record the programming over a network to a network attached storage device. For proper playback and support of trick modes, the record client (e.g., the STB) sends to the storage server not only the video data, but also the index data that describes the group of picture (GOP) structure of the video data, the frame types, the frame boundaries, etc. The RAVE 300 can capture the main data stream in the CDB 412 and can generate and load the index data in an ITB 414. The STB 114 can send to the server 122 both CDB data and ITB data synchronously, without loss of any packets or synchronization. At the server 122, the combined CDB and ITB stream may be separated and recorded into separate file descriptors.

The techniques described herein can be used in a LAN (e.g., a home LAN) that can include multiple recording devices (e.g., STB's) in various parts of the home. The server 122 can be another settop box, but could in general be any network attached storage. During playback, because the server 122 now has available to it the index data, trick modes (e.g., skip, rewind and frame-advance, frame-backwards etc.) can be supported without further computations with the audiovisual data stream, just by referring to the index data that was received over the network. An advantage of this technique is that when a user pauses or rewinds while watching a program that is remotely being recorded on a remote network server, the user will be able to instantaneously rewind. If a synchronized index were not available, the server would have to parse the frames, which would introduce latency and consume large amount of time.

While we describe these techniques in the context of sending synchronized data over a network in a lossless manner, the are also applicable to sending a main data stream and one or more metadata streams bundled together to a network server. That is, at the producer side, data from several producing sources can be multiplexed together to create a single network stream. Correspondingly, at the receiver side, data from the several sources can be demultiplexed by creating multiple socket interfaces or user readable network channels. Often the data may be made available at the receiver as separate sockets, or file descriptors. Even on a single file descriptor, various metadata and the main data type can be received as separate input/output control (IOCTL) system calls and read methods.

The error free transmission of the data from the STB 112 to the storage server 122 can be achieved by using a single TCP/IP connection for bundling and sending data. TCP/IP will retransmit and recover from packet losses in the network, thereby proving the resiliency needed. Our main implementation uses only one TCPIP connection for both data and metadata. However, alternatively, multiple independent TCP/IP connections may be used for the transmission.

When digital media data needs to be encrypted before sending it over the network, an effective way to extract index data is while the data is unencrypted in the STB's internal memory buffers. In fact using the RAVE at the client side, internally in firmware it is possible to extract the ITB data, while the CDB is being encrypted or scrambled. Then, the metadata for the index data can be sent along with the original digital media data, as the decrypt keys may not be passed onto the server.

The data can be streamed directly from the RAVE buffers in memory. We use a method of using Direct-Streaming from Ethernet/Network where network headers for Ethernet/IP/(TCPIP or UDP) protocols are gathered with payload data from the RAVE buffers to compose a network packet on the fly (scatter/gather DMA). Additional hardware requirements need not be imposed on RAVE except the ability to pause the recording if there is a temporary buffer overflow due to network congestion, and this is already supported via the read pointer update mechanism on the RAVE.

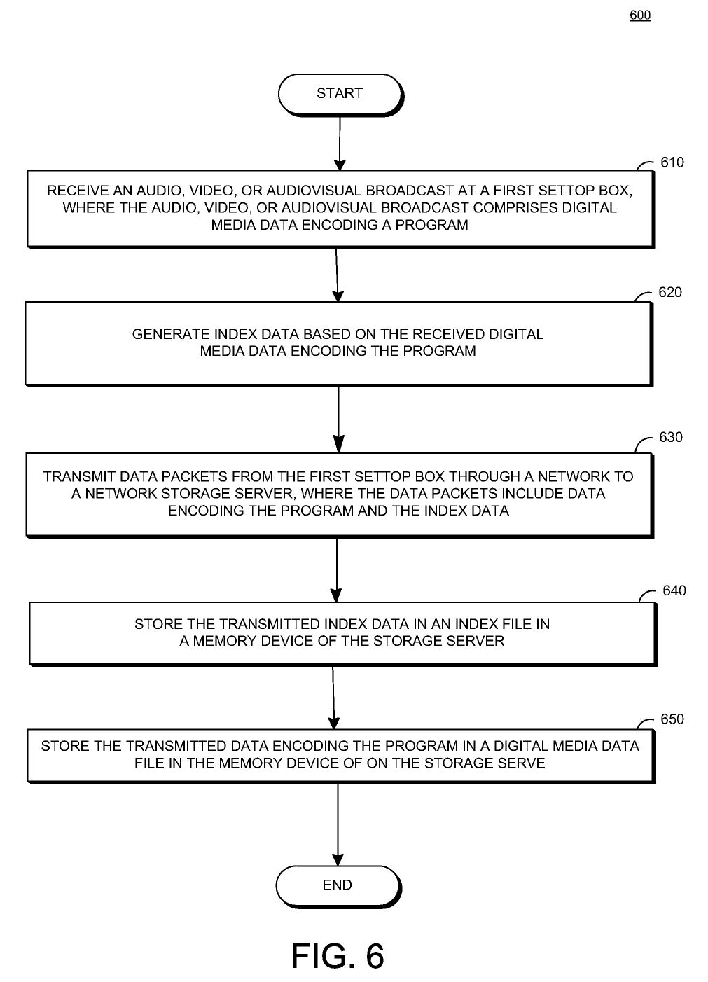

FIG. 6 is a flow chart of an exemplary method 600 than can be implemented using the devices and techniques described with reference to FIGS. 1-5B. After the method begins an audio, video, or audiovisual broadcast is received at a first settop box (step 610). For example, the broadcast can include digital media data encoding a program, such as a music, television, or other audiovideo program. In some implementations, the broadcast can include multiple programs, and a particular program can be selected from the broadcast by a tuner. After the program is received and selected out of the broadcast by the tuner, index data is generated based on the received digital media data encoding the program (step 620). The index data can be used to coordinate the playback of the program after the program has been stored on a network storage server. Data packets that include data encoding the program and the index data are transmitted from the first settop box through a network to a network storage server (step 630). The data encoding the program and the index data within the transmitted data packets can be demultiplexed after the data packets are received by the network storage server. Then, the transmitted index data is stored in an index file in a memory device of the storage server (step 640), and the transmitted data encoding the program is stored in a digital media data file in the memory device of on the storage server (step 650). The index data in the index file are configured to provide locations of data in the stored digital media data file marking entry points for playing back the digital media data file. For example, the index data can provide information about the location of I-frames in the program. Thus, when playing back the program from the network storage server to the first settop box or to another settop box, the index data can be used to quickly and efficiently located entry points in the program, so that trick modes can be used quickly and efficiently during playback.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While certain features of the described implementations have been illustrated as described herein, modifications, substitutions, and changes can be made.

What is claimed is:

1. A method comprising:
receiving an audio, video, or audiovisual broadcast at a first settop box, wherein the audio, video, or audiovisual broadcast comprises digital media data encoding a program;
generating index data based on the received digital media data encoding the program;
transmitting data packets from the first settop box through a network to a network storage server, wherein the data packets comprise data encoding the program and the index data; and
storing the transmitted index data in an index file in a memory device of the storage server;
storing the transmitted data encoding the program in a digital media data file in the memory device of on the storage server,
wherein the index data in the index file are configured to provide locations of data in the stored digital media data file marking entry points for playing back the digital media data file.

2. The method of claim 1, further comprising:
decrypting the received digital media data encoding the program; and
encrypting data encoding the program prior to transmitting the data packets comprising the encrypted data from the first settop box to the storage server.

3. The method of claim 1, wherein at least some of the transmitted data packets comprise both data encoding the program and index data.

4. The method of claim 3, further comprising parsing the transmitted data packets that comprise both data encoding the program and index data at the storage server to separate the data encoding the program and the index data.

5. The method of claim 1, further comprising:
streaming the program from the storage server to a settop box for playback with the settop box; and
locating at least one entry point in the program based on index data stored in the index file in response to a trick mode request from the settop box.

6. The method of claim 5, wherein the settop box to which the program is streamed is a second settop box that is different from the first settop box.

7. The method of claim 5, wherein the streaming and the locating in response to a trick mode request occurs while the data packets are transmitted from the first settop box through the network to the network storage server.

8. The method of claim 1, further comprising:
loading the index data into a first buffer on the first settop box;
loading the data encoding the program into a second buffer on the first settop box and
wherein transmitting the data packets from the first settop box through the network to a network storage server comprises reading index data and data encoding the program from the buffers and generating the data packets based on the read-out data.

9. The method of claim 1 wherein the index file comprises SCIT data.

10. The method of claim 1, wherein the network comprises a wireless network.

11. The method of claim 1, wherein transmitting the data packets from the first settop box through a network to the network storage server comprises transmitting the data packets according to a TCP/IP network protocol.

12. The method of claim 1, wherein the first settop box and the network device are located within the same building.

13. A system for allowing trick mode playback of a digital media program over a network, the system comprising:
a first settop box, wherein the settop box comprises:
a tuner adapted to receive an audio, video, or audiovisual broadcast, wherein the audio, video, or audiovisual broadcast comprises digital media data encoding a program, and further adapted to demultiplex the program from the broadcast;
an index data generation engine adapted to generate index data based on the digital media data encoding the program;
a first buffer adapted to store the index data;
a second buffer adapted to store data encoding the program; and
a network interface device adapted to transmit data packets through a network to a network storage server, wherein the data packets comprise data encoding the program and the index data that have been read out of the second and first buffers, respectively,
wherein the index data can be used to provide locations of data in the digital media data file stored on the storage server marking entry points for playing back the digital media data file from the storage server.

14. The system claim 13, wherein the network comprises a wireless network.

15. The system of claim 13, wherein the first settop box is a diskless settop box.

16. The system of claim 13, wherein the first settop box comprises a RAVE that includes the index generation engine.

17. The system of claim 13, further comprising a storage server connected to the first settop box through the network, the storage server comprising:
a memory device adapted to store the index data received from the first settop box in an index file and adapted to store data encoding the program in a digital media data file.

18. The system of claim 13, wherein the first settop box is located within the same building as the network device.

19. The system of claim 13, wherein the storage server further comprises a playback engine adapted to:
stream the program from the storage server to a settop box for playback with the settop box; and
locate at least one entry point in the program based on index data stored in the index file in response to a trick mode request from the settop box.

20. The method of claim 19, wherein the settop box to which the program is streamed is a second settop box that is different from the first settop box.

21. The method of claim 19, wherein playback engine is adapted to stream the program and locate the entry point in response to a trick mode request while the data packets are transmitted from the first settop box through the network to the network storage server.
